(19) United States
(12) Patent Application Publication
(10) Pub. No.: US 2024/0040534 A1
(43) Pub. Date: Feb. 1, 2024

(54) POSITIONING A DEVICE ASSOCIATED WITH MULTIPLE NETWORK SUBSCRIPTIONS

(71) Applicant: NOKIA TECHNOLOGIES OY, Espoo (FI)

(72) Inventors: Benny VEJLGAARD, Gistrup (DK); Johannes HARREBEK, Aalborg (DK); Ryan KEATING, Chicago, IL (US)

(73) Assignee: NOKIA TECHNOLOGIES OY, Espoo (FI)

(21) Appl. No.: 18/256,687

(22) PCT Filed: Nov. 26, 2021
(86) PCT No.: PCT/FI2021/050812

§ 371 Date: Jun. 9, 2023

(30) Foreign Application Priority Data
Dec. 11, 2020 (FI) 20206283

(51) Int. Cl. H04W 64/00; G01S 5/14

(52) U.S. Cl. CPC H04W 64/00; G01S 5/14

(57) ABSTRACT

Disclosed is a method comprising obtaining a first positioning reference signal configuration from at least a first serving access node (330) and a first neighbour access node (320) comprised in a first network, wherein the apparatus (310) is associated with a first network subscription to the first network, determining first positioning information by receiving a first positioning reference signal based on the obtained first positioning reference signal configuration, obtaining a second positioning reference signal configuration from a second serving access node (360) and a second neighbour access node (350) in a second network, wherein the apparatus is further associated with a second network subscription to the second network, determining second positioning information by receiving a second positioning information reference signal based on the obtained second positioning reference signals, estimating clock frequency difference between the first network and the second network and determining an offset between the first network and the second network, removing the determined offset from the obtained first positioning reference signal and the second positioning signal, and determining a joint positioning information by using the first and the second positioning information.

### FIELD

The following exemplary embodiments relate to wireless communication and to a device that is associated with a plurality of subscriptions.

### BACKGROUND

Wireless communication networks, such as cellular communication networks, allows devices to freely move from one area to another. In order to avoid carrying multiple devices, a user may have one device that is associated with multiple network subscriptions. This may be for example the case if the user has one network subscription as for professional use and another one for personal use.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to a first aspect there is provided an apparatus comprising means for obtaining a first positioning reference signal configuration from at least a first serving access node and a first neighbour access node comprised in a first network, wherein the apparatus is associated with a first network subscription to the first network, determining first positioning information by receiving a first positioning reference signal based on the obtained first positioning reference signal configuration, obtaining a second positioning reference signal configuration from a second serving access node and a second neighbour access node in a second network, wherein the apparatus is further associated with a second network subscription to the second network, determining second positioning information by receiving a second positioning information reference signal based on the obtained second positioning reference signals, estimating clock frequency difference between the first network and the second network and determining an offset between the first network and the second network, removing the determined offset from the obtained first positioning reference signal and the second positioning signal, and determining a joint positioning information by using the first and the second positioning information.

According to a second aspect there is provided an apparatus comprising at least one processor, and at least one memory including a computer program code, wherein the at least one memory and the computer program code are configured, with the at least one processor, to cause the apparatus to obtain a first positioning reference signal configuration from at least a first serving access node and a first neighbour access node comprised in a first network, wherein the apparatus is associated with a first network subscription to the first network, determine first positioning information by receiving a first positioning reference signal based on the obtained first positioning reference signal configuration, obtain a second positioning reference signal configuration from a second serving access node and a second neighbour access node in a second network, wherein the apparatus is further associated with a second network subscription to the second network, determine second positioning information by receiving a second positioning information reference signal based on the obtained second positioning reference signals, estimate clock frequency difference between the first network and the second network and determine an offset between the first network and the second network, remove the determined offset from the obtained first positioning reference signal and the second positioning signal, and determine a joint positioning information by using the first and the second positioning information.

According to a third aspect there is provided a system comprising means for obtaining a first positioning reference signal configuration from at least a first serving access node and a first neighbour access node comprised in a first network, wherein the apparatus is associated with a first network subscription to the first network, determining first positioning information by receiving a first positioning reference signal based on the obtained first positioning reference signal configuration, obtaining a second positioning reference signal configuration from a second serving access node and a second neighbour access node in a second network, wherein the apparatus is further associated with a second network subscription to the second network, determining second positioning information by receiving a second positioning information reference signal based on the obtained second positioning reference signals, estimating clock frequency difference between the first network and the second network and determining an offset between the first network and the second network, removing the determined offset from the obtained first positioning reference signal and the second positioning signal, and determining a joint positioning information by using the first and the second positioning information.

According to a fourth aspect there is provided a computer program comprising instructions for causing an apparatus to perform at least the following: obtaining a first positioning reference signal configuration from at least a first serving access node and a first neighbour access node comprised in a first network, wherein the apparatus is associated with a first network subscription to the first network, determining first positioning information by receiving a first positioning reference signal based on the obtained first positioning reference signal configuration, obtaining a second positioning reference signal configuration from a second serving access node and a second neighbour access node in a second network, wherein the apparatus is further associated with a second network subscription to the second network, determining second positioning information by receiving a second positioning information reference signal based on the obtained second positioning reference signals, estimating clock frequency difference between the first network and the second network and determining an offset between the first network and the second network, removing the determined offset from the obtained first positioning reference signal and the second positioning signal, and determining a joint positioning information by using the first and the second positioning information.

According to a fifth aspect there is provided a computer program comprising instructions stored thereon for performing at least the following: obtaining a first positioning reference signal configuration from at least a first serving access node and a first neighbour access node comprised in a first network, wherein the apparatus is associated with a first network subscription to the first network, determining first positioning information by receiving a first positioning reference signal based on the obtained first positioning reference signal configuration, obtaining a second positioning reference signal configuration from a second serving access node and a second neighbour access node in a second network, wherein the apparatus is further associated with a second network subscription to the second network, determining second positioning information by receiving a second positioning information reference signal based on the obtained second positioning reference signals, estimating clock frequency difference between the first network and the second network and determining an offset between the first network and the second network, removing the determined offset from the obtained first positioning reference signal and the second positioning signal, and determining a joint positioning information by using the first and the second positioning information.

According to a sixth aspect there is provided a non-transitory computer readable medium comprising program instructions for causing an apparatus to perform at least the following: obtaining a first positioning reference signal configuration from at least a first serving access node and a first neighbour access node comprised in a first network, wherein the apparatus is associated with a first network subscription to the first network, determining first positioning information by receiving a first positioning reference signal based on the obtained first positioning reference signal configuration, obtaining a second positioning reference signal configuration from a second serving access node and a second neighbour access node in a second network, wherein the apparatus is further associated with a second network subscription to the second network, determining second positioning information by receiving a second positioning information reference signal based on the obtained second positioning reference signals, estimating clock frequency difference between the first network and the second network and determining an offset between the first network and the second network, removing the determined offset from the obtained first positioning reference signal and the second positioning signal, and determining a joint positioning information by using the first and the second positioning information.

According to a seventh aspect there is provided a non-transitory computer readable medium comprising program instructions stored thereon for performing at least the following: obtaining a first positioning reference signal configuration from at least a first serving access node and a first neighbour access node comprised in a first network, wherein the apparatus is associated with a first network subscription to the first network, determining first positioning information by receiving a first positioning reference signal based on the obtained first positioning reference signal configuration, obtaining a second positioning reference signal configuration from a second serving access node and a second neighbour access node in a second network, wherein the apparatus is further associated with a second network subscription to the second network, determining second positioning information by receiving a second positioning information reference signal based on the obtained second positioning reference signals, estimating clock frequency difference between the first network and the second network and determining an offset between the first network and the second network, removing the determined offset from the obtained first positioning reference signal and the second positioning signal, and determining a joint positioning information by using the first and the second positioning information.

According to an eight aspect there is provided a computer program product comprising instructions for causing an apparatus to perform at least the following: obtaining a first positioning reference signal configuration from at least a first serving access node and a first neighbour access node comprised in a first network, wherein the apparatus is associated with a first network subscription to the first network, determining first positioning information by receiving a first positioning reference signal based on the obtained first positioning reference signal configuration, obtaining a second positioning reference signal configuration from a second serving access node and a second neighbour access node in a second network, wherein the apparatus is further associated with a second network subscription to the second network, determining second positioning information by receiving a second positioning information reference signal based on the obtained second positioning reference signals, estimating clock frequency difference between the first network and the second network and determining an offset between the first network and the second network, removing the determined offset from the obtained first positioning reference signal and the second positioning signal, and determining a joint positioning information by using the first and the second positioning information.

According to a ninth aspect there is provided a method comprising obtaining a first positioning reference signal configuration from at least a first serving access node and a first neighbour access node comprised in a first network, wherein the apparatus is associated with a first network subscription to the first network, determining first positioning information by receiving a first positioning reference signal based on the obtained first positioning reference signal configuration, obtaining a second positioning reference signal configuration from a second serving access node and a second neighbour access node in a second network, wherein the apparatus is further associated with a second network subscription to the second network, determining second positioning information by receiving a second positioning information reference signal based on the obtained second positioning reference signals, estimating clock frequency difference between the first network and the second network and determining an offset between the first network and the second network, removing the determined offset from the obtained first positioning reference signal and the second positioning signal, and determining a joint positioning information by using the first and the second positioning information.

### LIST OF DRAWINGS

In the following, some exemplary embodiments are described with reference to the accompanying drawings in which:

FIG. 1 illustrates an exemplary embodiment of a radio access network.

FIG. 2 illustrates an exemplary embodiment in which locating a terminal device may not be possible.

FIG. 3 illustrates in which a terminal device may utilize multiple networks for positioning.

FIG. 4 illustrates an exemplary embodiment of signalling between a terminal device and two networks.

FIG. 5 illustrates an exemplary embodiment in which the location of a terminal device is determined responsive to an initiation from a network.

FIG. 6 illustrates an exemplary embodiment of an architecture that may be utilized in a terminal device.

FIG. 7 illustrates a flow chart according to an exemplary embodiment.

FIG. 8 illustrates an exemplary embodiment of an apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus (es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, microcontrollers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

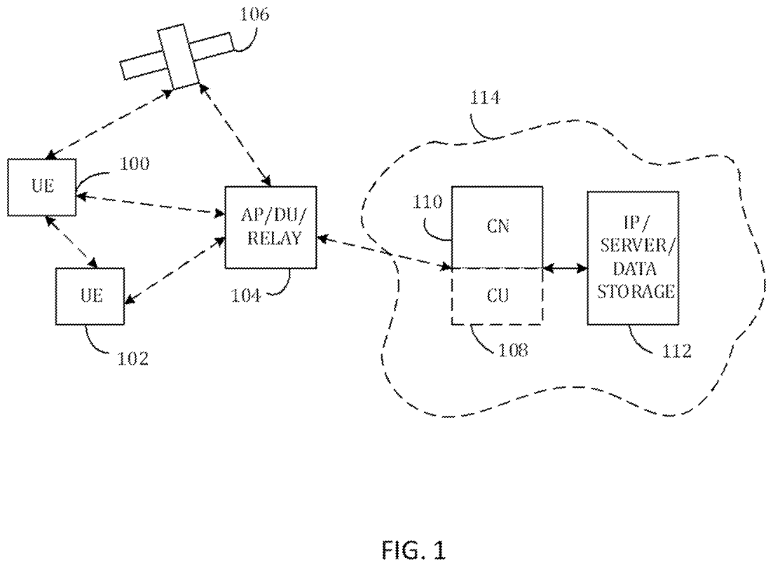

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1. The example of FIG. 1 shows a part of an exemplifying radio access network.

FIG. 1 shows terminal devices 100 and 102 configured to be in a wireless connection on one or more communication channels in a cell with an access node (such as (e/g)NodeB) 104 providing the cell. The access node 104 may also be referred to as a node. The physical link from a terminal device to a (e/g)NodeB is called uplink or reverse link and the physical link from the (e/g)NodeB to the terminal device is called downlink or forward link. It should be appreciated that (e/g)NodeBs or their functionalities may be implemented by using any node, host, server or access point etc. entity suitable for such a usage. It is to be noted that although one cell is discussed in this exemplary embodiment, for the sake of simplicity of explanation, multiple cells may be provided by one access node in some exemplary embodiments.

A communication system may comprise more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The (e/g)NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side may be a serving gateway (S-GW, routing and forwarding user data packets), packet data network gateway (P-GW), for providing connectivity of terminal devices (UEs) to external packet data networks, or mobile management entity (MME), etc.

The terminal device (also called UE, user equipment, user terminal, user device, etc.) illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. Another example of such a relay node is a layer 2 relay. Such a relay node may contain a terminal device part and a Distributed Unit (DU) part. A CU (centralized unit) may coordinate the DU operation via F1AP-interface for example.

The terminal device may refer to a portable computing device that includes wireless mobile communication devices operating with or without a subscriber identification module (SIM), or an embedded SIM, eSIM, including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be an exclusive or a nearly exclusive uplink only device, of which an example is a camera or video camera loading images or video clips to a network. A terminal device may also be a device having capability to operate in Internet of Things (IoT) network which is a scenario in which objects are provided with the ability to transfer data over a network without requiring human-to-human or human-to-computer interaction. The terminal device may also utilise cloud. In some applications, a terminal device may comprise a small portable device with radio parts (such as a watch, earphones or eyeglasses) and the computation is carried out in the cloud. The terminal device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G may require to bring the content close to the radio which may lead to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, and/or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology that may be used includes for example Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling or service availability in areas that do not have terrestrial coverage. Possible use cases comprise providing service continuity for machine-to-machine (M2M) or Internet of Things (IoT) devices or for passengers on board of vehicles, and/or ensuring service availability for critical communications, and/or future railway/maritime/aeronautical communications. Satellite communication may utilise geostationary earth orbit (GEO) satellite systems, but also low earth orbit (LEO) satellite systems, for example, mega-constellations (systems in which hundreds of (nano)satellites are deployed). A satellite 106 comprised in a constellation may carry a gNB, or at least part of the gNB, that create on-ground cells. Alternatively, a satellite 106 may be used to relay signals of one or more cells to the Earth. The on-ground cells may be created through an on-ground relay node 104 or by a gNB located on-ground or in a satellite or part of the gNB may be on a satellite, the DU for example, and part of the gNB may be on the ground, the CU for example. Additionally, or alternatively, high-altitude platform station, HAPS, systems may be utilized. HAPS may be understood as radio stations located on an object at an altitude of 20-50 kilometres and at a fixed point relative to the Earth. Alternatively, HAPS may also move relative to the Earth. For example, broadband access may be delivered via HAPS using lightweight, solar-powered aircraft and airships at an altitude of 20-25 kilometres operating continually for several months for example.

It is to be noted that the depicted system is an example of a part of a radio access system and the system may comprise a plurality of (e/g)NodeBs, the terminal device may have an access to a plurality of radio cells and the system may comprise also other apparatuses, such as physical layer relay nodes or other network elements, etc. At least one of the (e/g)NodeBs may be a Home (e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In some exemplary embodiments, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. A network which is able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network may aggregate traffic from a large number of HNBs back to a core network.

A terminal device may have capability of connecting to a plurality of network subscriptions simultaneously. For example, the terminal device may have simultaneous subscriptions to two or more networks that follow 3GPP or 3GPP2 standards. Such subscriptions may be via international mobile subscriber identities, IMSI for evolve packet system, EPS. IMSI is a unique ID that globally identifies a mobile subscriber and the IMSI may be comprised in a USIM card comprised in a terminal device. Each network subscription may be associated with a subscription belonging to the same or different mobile network operator, MNO or, mobile virtual network operator, MVNO. The terminal device may thus be a multi-USIM, MUSIM, device.

In a terminal device that is a MUSIM device, the terminal device may manage the multiple network subscriptions independently without involvement from an access node. The terminal device may for example select which service may run using which network subscription. It is to be noted that each network subscription associated with different type of subscription and quality of service.

A terminal device may be located in terms of its physical location using various methods for locating. For example, 3GPP standards introduce the following positioning solutions: downlink time difference of arrival, DL-TDOA, uplink time difference of arrival, UL-TDOA, downlink angle of departure, DL-AoD, uplink angle of arrival, UL-AoA, and Multi-cell round trip time, Multi-RTT. If a positioning based on time difference of arrival, TDOA, round trip time, RTT, or angle of arrival, AoA, is to be utilized, at least three or four access nodes are to be visible as the locating requires triangulation to be calculated.

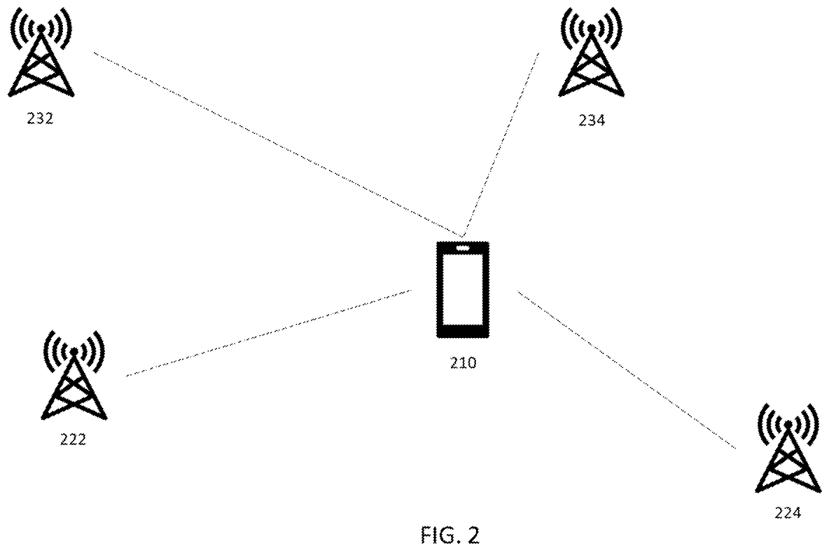

FIG. 2 illustrates an exemplary embodiment in which locating a terminal device may not be possible. In this exemplary embodiment, there is a terminal device 210, such as a mobile phone, that is a MUSIM device associated with two network subscriptions, a first network subscription to the first network and a second network subscription to a second network. The terminal device 210 is in this exemplary embodiment visible to four access nodes that in this exemplary embodiment are gNBs. The gNB 222 and the gNB 224 are part of the first network to which the first network subscription associated with the terminal device 210 is. The gNB 232 and the gNB 234 are part of the second network to which the second network subscription associated with the terminal device 210 is. As the terminal device 210 is visible to only two access nodes per each network subscription associated with the terminal device 210, a triangulation is not possible by either network in this exemplary embodiment and therefore locating the terminal device based on calculating triangulation is not possible even though the terminal device is visible to four access nodes as such.

It is to be noted that in some exemplary embodiments, a terminal device may need to be visible to more than three or four access nodes for the purpose of determining the location of the terminal device. This may be the case for example in environments that do not have a line of sight, LoS, between the terminal device and access nodes. In general, the more access nodes there are that may be utilized for the positioning of a terminal device, the more accurate the positioning result may be. Yet, in some environments, for example in rural areas and indoors, it may be difficult to obtain at least three available access nodes for the purpose of positioning a terminal device.

Yet, in case there are at least three access nodes available as such, like in the exemplary embodiment of FIG. 2, but not all of those are available to a single network subscription associated with a terminal device such that the triangulation cannot be calculated, it would be beneficial to obtain a way to overcome the limitation caused by the access nodes being associated with different network subscriptions. It would also be beneficial to increase positioning accuracy by including more access nodes when there is no LoS between the terminal device and one or more access nodes.

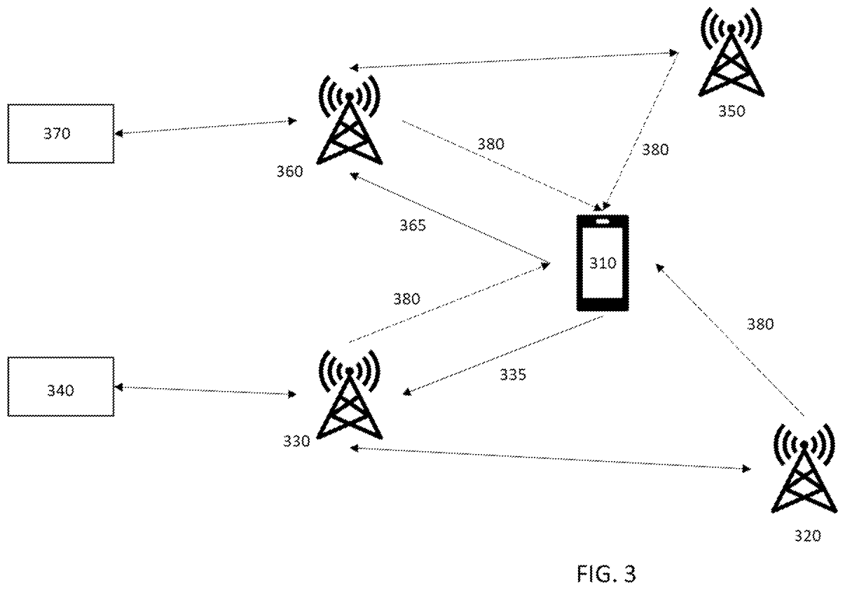

FIG. 3 illustrates an exemplary embodiment in which a terminal device 310 may utilize multiple networks for positioning to obtain a higher number of access nodes for triangulation. In this exemplary embodiment, the terminal device 310 is associated with a first network subscription to a first network and a second network subscription to second network. The first network comprises access nodes 320 and 330 that in this exemplary embodiment are gNBs and to which the terminal device is visible. The first network further comprises a location management function, LMF, 340. A location management function, LMF, processes requests for location services such as transferring data to a terminal device 310 via an access node to assist with positioning of the terminal device. The LMF may be implemented, in some exemplary embodiments, in a core network. Alternatively, in some other exemplary embodiments, the LMF may be implemented in random access network, RAN, as a local component. The second network comprises access nodes 350 and 360 that in this exemplary embodiment are also gNBs and to which the terminal device 310 is also visible. The second network further comprises a location management function, LMF, 370. The LMF may implemented in the core network or in the RAN as a local component like in the first network. In this exemplary embodiment, the terminal device 310 would have only two access nodes available for determining its location if the location is to be determined based on one network. However, if both the first and the second network are utilized for determining the position of the terminal device 310, then at least three access nodes are available for triangulation calculations and/or more accurate positioning of the terminal device.

In this exemplary embodiment, the terminal device 310 may request a downlink positioning from the serving cell provided by the access node 330 of the first network. When the terminal device 310 requests the downlink positioning, it may use, for example, LTE positioning protocol, LPP, to do so. The terminal device 310 may transmit to the access node 330 a positioning reference signal, PRS, request 335. PRS may be used by various 5G positioning techniques such as RTT, AoA, AoD and TDOA. In this exemplary embodiment, DL-TDOA is utilized. The terminal device 310 also transmits a PRS request 365 to the access node 360 that provides a serving cell of the second network. DL-TDOA is utilized in this exemplary embodiment for the positioning using the second network as well. The terminal device 310 then receives PRS 380 from all access nodes 320, 330, 350 and 360. The two granted PRS are provided on two different frequency bands in this exemplary embodiment.

It is to be noted that a positioning reference signal is an example of a reference signal that could be utilized. In some other exemplary embodiments, other reference signals may be used for positioning. Examples of such reference signals comprise synchronization signal block, SSB, and channel state information reference symbol, CSI-RS.

The terminal device 310 may then utilize TDOA measurements on the first and the second network with a different reference PRS and estimate a clock frequency difference between the two networks using physical random access channel, PRACH, and PRS signals. The estimated difference, that is a time offset between the two networks, may then be used to jointly estimate the position from both networks. The frequency offset component may then be removed by the terminal device 310 based on the downlink reference signals and the terminal device may then calculate TDOA from both networks and perform the triangulation using information from both networks.

Although in this exemplary embodiment there are four access nodes in total, in some other exemplary embodiments there may be another number of access nodes, such as gNBs. For example, if a terminal device is associated with at least two different network subscriptions and the respective two networks are using a shared spectrum, the networks may configure the terminal device to utilize the same reference PRS for measurements on both networks. Additionally, in some exemplary embodiments, the terminal device may use the same reference PRS on different spectrum. Further, timing measurement accuracy may be enhanced by using co-located sites. For example, a weighted average of the two set of measurements may be utilized. The terminal device may also capture PRS in parallel from both networks if it comprises a dual RX architecture. The procedure described above may also be extended to RTT measurements.

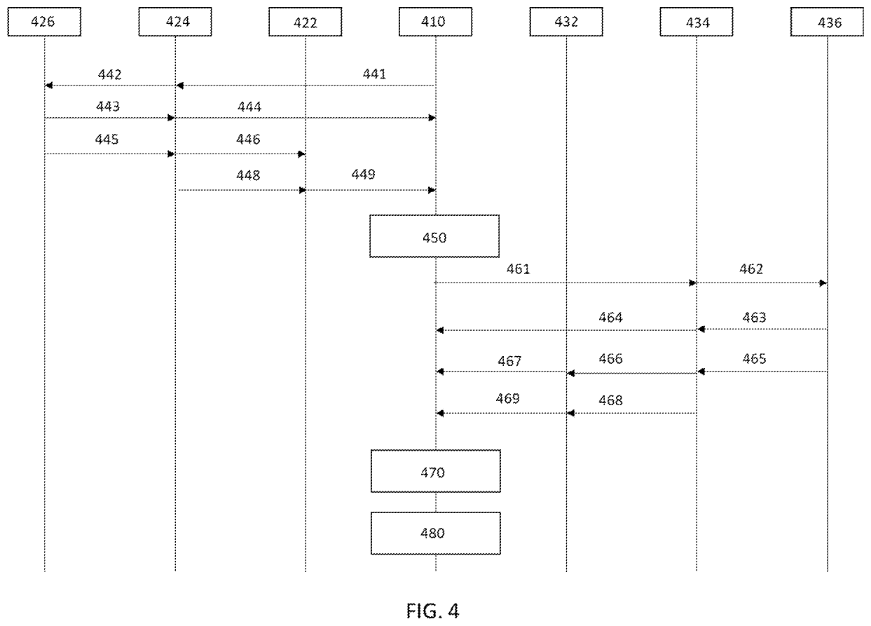

FIG. 4 illustrates an exemplary embodiment of signalling between a terminal device 410 and two networks. The terminal device 410, which is a MUSIM device, is associated with a first network subscription to the first network and with a second network subscription to the second network. In this exemplary embodiment, the terminal device determines it position utilizing positioning requests to the first network and to the second network. The first network comprises a first neighbour cell provided by an access node 422, which is a gNB in this exemplary embodiment, a first serving cell provided by an access node 424, which is a gNB in this exemplary embodiment, and a first LMF 426 to which the access node 422 and 424 are connected to. The second network comprises a second neighbour cell provided by an access node 432, which is a gNB in this exemplary embodiment, a second serving cell provided by an access node 434, which is a gNB in this exemplary embodiment, and a second LMF 436 to which the access node 432 and 434 are connected to.

The positioning in this exemplary embodiment is initiated by the terminal device 410. The terminal device 410 first transmits a positioning request 441 to the access node 424 comprised in the first network. The positioning request may be a PRS request. In this exemplary embodiment, DL-TDOA is used for positioning. The access node 424 then transmits a signal 442 to the LMF 426 indicating that the terminal device has transmitted a positioning request. The LMF 426 then transmits signalling 443 to the access node 424 acknowledging the positioning request and the access node 424 also transmits a signal 444 to the terminal device 410 acknowledging the positioning request. The LMF 426 also transmits a configuration signal, which may be transmitted together with the acknowledgment signalling, to the terminal device 410 for the PRS reception. Thus, the terminal device 410 knows what to measure and when. The LMF 426 then transmits a signal 445 to the access node 424 configuring the access node 424 for downlink PRS transmission. A configuration signal 446 is transmitted by the LMF 424 to the access node 422 as well. Next, the access node 424 will transmit the PRS 448 to the terminal device 410 and the access node 422 will also transmit the PRS 449 to the terminal device 410. Once the terminal device has received the PRS from the access node 424 and the access node 422, it will determine DL-TDOA respective to the first network 450.

In a likewise manner, the terminal device 410 will then request a terminal device based DL positioning from the second serving cell comprised in the second network using DL-TDOA. The terminal device 410 transmits a positioning request 461 to the access node 434 comprised in the second network. The positioning request may be a PRS request. The access node 434 then transmits a signal 462 to the LMF 436 indicating that the terminal device 410 has transmitted a positioning request. The LMF 436 then transmits signalling 463 to the access node 434 acknowledging the positioning request and the access node 434 also transmits a signal 464 to the terminal device 410 acknowledging the positioning request. The LMF 436 then transmits a signal 465 to the access node 434 configuring the access node 434 for downlink PRS transmission. A configuration signal 466 is transmitted by the LMF 434 to the access node 432 as well and a configuration signal 467 is transmitted to the terminal device 410 to configure the terminal device for the PRS as well. Next, the access node 434 will transmit the PRS 468 to the terminal device 410 and the access node 432 will also transmit the PRS 469 to the terminal device 410. Once the terminal device has received the PRS from the access node 434 and the access node 432, it will determine DL-TDOA respective to the second network 470.

It is to be noted that the terminal device 410 is granted PRS from the first network and from the second network. The PRS from the first network may be on different frequency band than the PRS from the second network. The terminal device 410 performs, in this exemplary embodiment, TDOA measurements on the first and the second network with a different reference PRS. The terminal device 410 may then estimate a clock frequency difference between the first and the second network. This may be estimated based on for example PRACH and PRS signals. The terminal device 410 may then remove the frequency offset component based on the DL reference signals. Then the terminal device 410 determines its location based on the positioning signals received from the first and the second network. In this exemplary embodiment, the terminal device 410 determines a joint downlink TDOA and performs triangulation calculations based on positioning reference signals received from both the first and the second network 480. It is to be noted that in this exemplary embodiment, the terminal device 410 is provided the location of the access nodes 422, 424, 432 and 434 from their respective networks during the procedure described above.

Additionally, in some exemplary embodiments, if broadcasting of positioning data is being used by one or both of the networks, the terminal device 410 may also receive either the DL PRS configuration or locations of the access nodes via broadcast. In such exemplary embodiments, the requesting signals described above may be replaced by measuring the broadcast data. Thus, the implementation of the terminal device obtaining PRS configuration signalling and/or information regarding locations of the access nodes may vary in different exemplary embodiments.

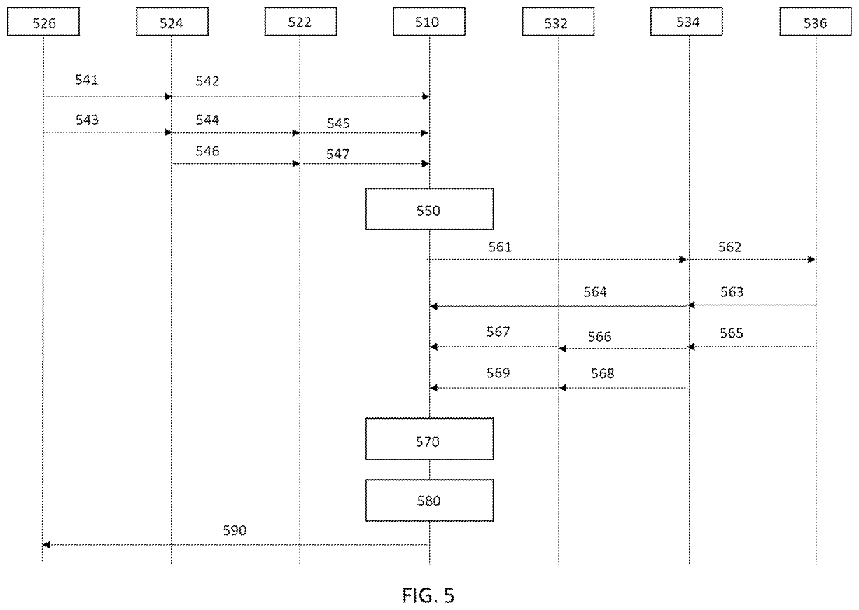

In some exemplary embodiments, the location may be determined based on an initiation coming from a network. This may be the case for example when enhanced 911 is utilized to locate a terminal device in case of an emergency. FIG. 5 illustrates an exemplary embodiment in which the location of a terminal device 510 is determined responsive to an initiation from a network.

In this exemplary embodiment, the terminal device 510 is a MUSIM device that is associated with a first network subscription to a first network and a second network subscription to the second network. The first network comprises a first neighbour cell provided by an access node 522, which is a neighbour access node and a gNB in this exemplary embodiment, a first serving cell provided by an access node 524, which is a serving access node and a gNB in this exemplary embodiment, and a first LMF 526 to which the access node 522 and 524 are connected to. The second network comprises a second neighbour cell provided by an access node 532, which is a neighbour access node and a gNB in this exemplary embodiment, a second serving cell provided by an access node 534, which is a serving access node and a gNB in this exemplary embodiment, and a second LMF 536 to which the access node 532 and 534 are connected to.

In this exemplary embodiment, the LMF 526, transmits signalling 541 to the access node 524 configuring the access node 524 for positioning request. The terminal device 510 also obtains configuration for positioning request by receiving signalling 542 from the access node 524. The LMF 526 then transmits signalling 543 to the access node 524 and configures the access node 524 for PRS transmission. The LMF 526 also transmits signalling 544 to the access node 522 and configures the access node 522 for PRS transmission. The terminal device 510 also obtains signalling 545 from the LMF 526, via the serving gNB 524, configuring the terminal device for PRS reception. The access node 524 then transmits the PRS 546 to the terminal device 510 and the access node 522 transmits the PRS 547 to the terminal device 510. The terminal device then determines positioning information respective to the first network, which in this exemplary embodiment comprises determining the DL-TDOA respective to the first network 550.

Next, the terminal device 510 requests a terminal device based DL positioning from the second serving cell comprised in the second network using DL-TDOA. The terminal device 510 transmits a positioning request 561 to the access node 534 comprised in the second network. The positioning request may be a PRS request. The access node 534 then transmits a signal 562 to the LMF 536 indicating that the terminal device 510 has transmitted a positioning request. The LMF 536 then transmits signalling 563 to the access node 534 acknowledging the positioning request and the access node 534 also transmits a signal 564 to the terminal device 510 acknowledging the positioning request. The LMF 536 then transmits a signal 565 to the access node 534 configuring the access node 534 for downlink PRS transmission. A configuration signal 566 is transmitted by the LMF 534 to the access node 532 as well and a configuration signal 567 is transmitted to the terminal device 510 to configure the terminal device for the PRS as well. Next, the access node 534 will transmit the PRS 568 to the terminal device 510 and the access node 532 will also transmit the PRS 569 to the terminal device 510. Once the terminal device 510 has received the PRS from the access node 534 and the access node 532, it will determine positioning information respective to the second network, that in this exemplary embodiment comprises DL-TDOA respective to the second network 570.

In this exemplary embodiment, the PRS received by the terminal device 510 from the first network is transmitted using the frequency band of the first network and the PRS received by the terminal device 510 from the second network is transmitted using the frequency band of the second network. The terminal device 510 determines a joint positioning information based on the positioning information determined respective to the first network and positioning information determined respective to the second network. This comprises in this exemplary embodiment determining a joint DL TDOA respective to the first and the second network 580. The terminal device 510 then transmits indication of the determined joint positioning information to the LMF 526 using signal 590.

It is to be noted that in some exemplary embodiments the first and the second network may use a shared spectrum. In such an exemplary embodiment, the terminal device may use the same reference PRS for measurements on both networks. Also, co-located sites may be used to further enhance timing measurement accuracy for example by using weighted average of the two set of measurements. Further, in some exemplary embodiment, the terminal device may be able to capture PRS in parallel from both networks based on dual RX architecture comprised in the terminal device. Yet, if dual RX architecture is not comprised in the terminal device, the terminal device may request measurement gaps on the first network in order to measure the PRS from the second network.

It is also to be noted that the procedure described above may also be extended to DL-AoD techniques in which the terminal device utilizes received PRS-RSRP to estimate the AoD from each gNB as an additional positioning measurement.

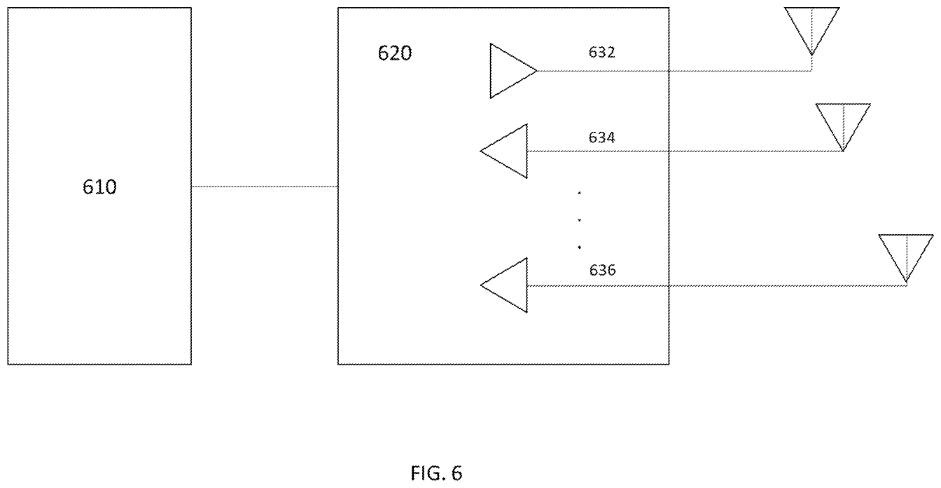

FIG. 6 illustrates an exemplary embodiment of an architecture that may be utilized in a terminal device that is a MUSIM device. In this exemplary embodiment, the terminal device comprises a baseband unit 610 and a transceiver unit 620. These units may be understood as logical units. The transceiver unit comprises a transmitter and a transmitter path 632 and multiple receivers and receiver paths 634, 636. In some exemplary embodiments, due to intermodulation, the terminal device may not support inter-band UL carrier aggregation but only inter-band carrier aggregation where the UL aggregated bands are combined into a single UL signal before being modulated and transmitted. Yet, in downlink multiple receive chains may operate independently and thereby support inter-band carrier aggregation. Such downlink architecture enables parallel reception of PRS from multiple networks as the networks may operate on two different licensed bands. The architecture illustrated in this exemplary embodiment further enables PRS reception in parallel. Such parallel reception may have the benefit of being both cost and power efficient. The terminal device may receive from both networks using same reference clock domain which will put some requirements on time synchronisation between the networks. One of the networks may be used as the master timing reference for clock sync.

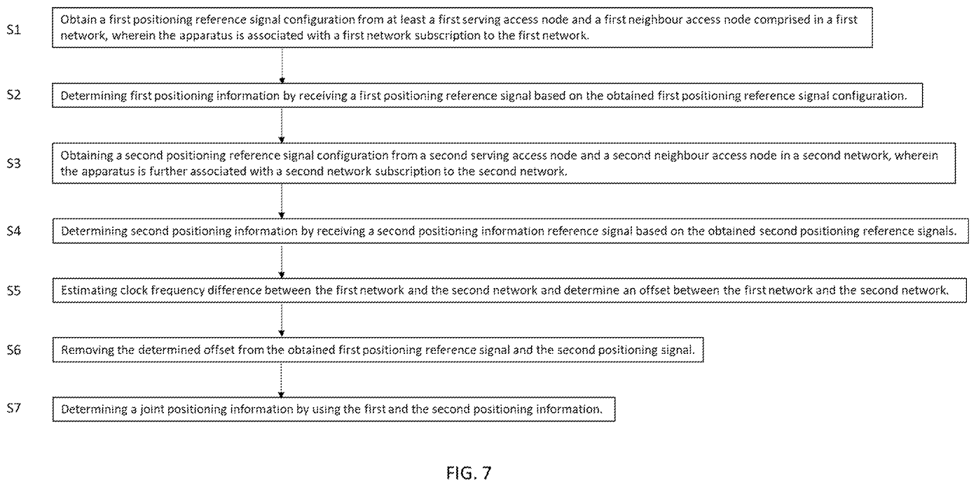

FIG. 7 illustrates a flow chart according to an exemplary embodiment. In this flow chart, first in S1 a first positioning reference signal configuration is obtained from at least a first serving access node and a first neighbour access node comprised in a first network, wherein the apparatus is associated with a first network subscription to the first network. Next, in S2, a first positioning information is determined by receiving a first positioning reference signal based on the obtained first positioning reference signal configuration. Then in S3 a second positioning reference signal configuration is obtained from a second serving access node and a second neighbour access node in a second network, wherein the apparatus is further associated with a second network subscription to the second network. Next, in S4, a second positioning information is determined by receiving a second positioning information reference signal based on the obtained second positioning reference signals. In S5, a clock frequency difference between the first network and the second network is estimated and an offset between the first network and the second network is determined. Then in S6 the determined offset is removed from the obtained first positioning reference signal and the second positioning signal. Finally, in S7 a joint positioning information is determined by using the first and the second positioning information.

The exemplary embodiments described above may have advantages such as enabling estimation of a position of a terminal device even when there are less than three access nodes of a network available for positioning as long as there are at least one access node of another network available as well. Thus, the positioning may be performed by utilizing access nodes of more than one network. A further advantage that may be achieved by the exemplary embodiments described above is that in indoor places such as parking garages more access nodes may be utilized for positioning, which may increase the accuracy of the positioning. For example, an error of the positioning may be reduced by half when utilizing the exemplary embodiments described above.

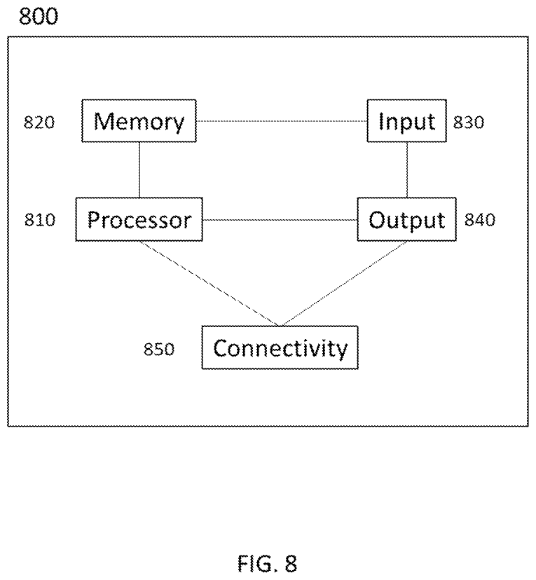

FIG. 8 illustrates an apparatus 800, which may be an apparatus such as, or comprised in, a terminal device, according to an example embodiment. The apparatus 800 comprises a processor 810. The processor 810 interprets computer program instructions and processes data. The processor 810 may comprise one or more programmable processors. The processor 810 may comprise programmable hardware with embedded firmware and may, alternatively or additionally, comprise one or more application specific integrated circuits, ASICs.

The processor 810 is coupled to a memory 820. The processor is configured to read and write data to and from the memory 820. The memory 820 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 820 stores computer readable instructions that are execute by the processor 810. For example, non-volatile memory stores the computer readable instructions and the processor 810 executes the instructions using volatile memory for temporary storage of data and/or instructions.

The computer readable instructions may have been pre-stored to the memory 820 or, alternatively or additionally, they may be received, by the apparatus, via electromagnetic carrier signal and/or may be copied from a physical entity such as computer program product. Execution of the computer readable instructions causes the apparatus 800 to perform functionality described above.

In the context of this document, a “memory” or “computer-readable media” may be any non-transitory media or means that can contain, store, communicate, propagate or transport the instructions for use by or in connection with an instruction execution system, apparatus, or device, such as a computer.

The apparatus 800 further comprises, or is connected to, an input unit 830. The input unit 830 comprises one or more interfaces for receiving a user input. The one or more interfaces may comprise for example one or more motion and/or orientation sensors, one or more cameras, one or more accelerometers, one or more microphones, one or more buttons and one or more touch detection units. Further, the input unit 830 may comprise an interface to which external devices may connect to.

The apparatus 800 also comprises an output unit 840. The output unit comprises or is connected to one or more displays capable of rendering visual content such as a light emitting diode, LED, display, a liquid crystal display, LCD and a liquid crystal on silicon, LCoS, display. The output unit 840 may further comprise one or more audio outputs. The one or more audio outputs may be for example loudspeakers or a set of headphones.

The apparatus 800 may further comprise a connectivity unit 850. The connectivity unit 850 enables wired and/or wireless connectivity to external networks. The connectivity unit 850 may comprise one or more antennas and one or more receivers that may be integrated to the apparatus 800 or the apparatus 800 may be connected to. The connectivity unit 850 may comprise an integrated circuit or a set of integrated circuits that provide the wireless communication capability for the apparatus 800. Alternatively, the wireless connectivity may be a hardwired application specific integrated circuit, ASIC.

It is to be noted that the apparatus 800 may further comprise various component not illustrated in the FIG. 8. The various components may be hardware component and/or software components.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising at least one processor, and at least one memory storing instructions that, when executed by the at least one processor, cause the apparatus to:
obtain a first positioning reference signal configuration from at least a first serving access node and a first neighbour access node comprised in a first network, wherein the apparatus is associated with a first network subscription to the first network;
determine first positioning information by receiving a first positioning reference signal based on the obtained first positioning reference signal configuration;
obtain a second positioning reference signal configuration from a second serving access node and a second neighbour access node in a second network, wherein the apparatus is further associated with a second network subscription to the second network;
determine second positioning information by receiving a second positioning information reference signal based on the obtained second positioning reference signal configuration;
estimate a clock frequency difference between the first network and the second network and determine an offset between the first network and the second network;
remove the determined offset from the obtained first positioning reference signal and the second positioning information reference signal; and
determine a joint positioning information by using the first and the second positioning information.

2. An apparatus according to claim 1, wherein the apparatus is further caused to obtain the first positioning reference signal configuration after transmitting a first positioning request to the first serving access node.

3. An apparatus according to claim 1, wherein the apparatus is further caused to obtain the second positioning reference signal configuration after transmitting a second positioning request to the first serving access node.

4. An apparatus according to claim 1, wherein at least one of the following: the first positioning reference signal configuration or the second positioning reference signal configurations are obtained as broadcasts.

5. An apparatus according to claim 1, wherein the first positioning reference signal configuration is obtained from a frequency band used by the first network and the second positioning reference signal configuration is obtained from another frequency band used by the second network.

6. An apparatus according to claim 1, wherein the apparatus further comprises multiple receiver chains.

7. An apparatus according to claim 1, wherein the apparatus is further caused to transmit the joint positioning information.

8. An apparatus according to claim 1, wherein one or more of the first or second positioning information comprises received signal time difference or downlink time difference of arrival.

9. An apparatus according to claim 1, wherein the joint positioning information comprises an estimate of the location of the apparatus.

10. An apparatus according to claim 1, wherein the apparatus is further caused to use the first positioning reference signal configuration or the second positioning reference signal configuration for obtaining positioning information with respect to both the first and the second network.

11. An apparatus according to claim 1, wherein the apparatus is a terminal device.

12. A method comprising:
obtaining a first positioning reference signal configuration from at least a first serving access node and a first neighbour access node comprised in a first network, wherein the apparatus is associated with a first network subscription to the first network;
determining first positioning information by receiving a first positioning reference signal based on the obtained first positioning reference signal configuration;
obtaining a second positioning reference signal configuration from a second serving access node and a second neighbour access node in a second network, wherein the apparatus is further associated with a second network subscription to the second network;
determining second positioning information by receiving a second positioning information reference signal based on the obtained second positioning reference signal configuration;
estimating a clock frequency difference between the first network and the second network and determining an offset between the first network and the second network;
removing the determined offset from the obtained first positioning reference signal and the second positioning information reference signal; and
determining a joint positioning information by using the first and the second positioning information.

13. A non-transitory computer readable medium comprising program instructions that, when executed by an apparatus, cause the apparatus to perform at least the following:
obtain a first positioning reference signal configuration from at least a first serving access node and a first neighbour access node comprised in a first network, wherein the apparatus is associated with a first network subscription to the first network;
determine first positioning information by receiving a first positioning reference signal based on the obtained first positioning reference signal configuration;
obtain a second positioning reference signal configuration from a second serving access node and a second neighbour access node in a second network, wherein the apparatus is further associated with a second network subscription to the second network;
determine second positioning information by receiving a second positioning information reference signal based on the obtained second positioning reference signal configuration;
estimate a clock frequency difference between the first network and the second network and determining an offset between the first network and the second network;
remove the determined offset from the obtained first positioning reference signal and the second positioning information reference signal; and
determine a joint positioning information by using the first and the second positioning information.

14.-15. (canceled)

16. A method according to claim 12, wherein the method comprises obtaining the first positioning reference signal configuration after transmitting a first positioning request to the first serving access node.

17. A method according to claim 12, wherein the method comprises obtaining the second positioning reference signal configuration after transmitting a second positioning request to the first serving access node.

18. A method according to claim 12, wherein at least one of the following: the first positioning reference signal configuration or the second positioning reference signal configuration are obtained as broadcasts.

19. A method according to claim 12, wherein the first positioning reference signal configuration is obtained from a frequency band used by the first network and the second positioning reference signal configuration is obtained from another frequency band used by the second network.

20. A method according to claim 12, wherein the method further comprises multiple receiver chains.

21. A method according to claim 12, wherein the method further comprises transmitting the joint positioning information.

22. A method according to claim 12, wherein one or more of the first or second positioning information comprises received signal time difference or downlink time difference of arrival.
